(19) United States
(12) Patent Application Publication
(10) Pub. No.: US 2004/0128338 A1
(43) Pub. Date: Jul. 1, 2004

(54) Pipelined multiplicative division with IEEE rounding

(76) Inventors: Guy Even, Tel Aviv (IL); Peter-Michael Seidel, Dallas, TX (US)

Correspondence Address: NATH & ASSOCIATES, PLLC, Sixth Floor, 1030 15th Street, N.W., Washington, DC, 20005, US

(21) Appl. No.: 10/695,623

(22) Filed: Oct. 29, 2003

Related U.S. Application Data
(60) Provisional application No. 60/421,998, filed on Oct. 29, 2002.

(51) Int. Cl. G06F 7/52

(52) U.S. Cl. 708/650

(57) ABSTRACT

Apparatus and method for performing IEEE-rounded floating-point division utilizing Goldschmidt's algorithm. The use of Newton's method in computing quotients requires two multiplication operations, which must be performed sequentially, and therefore incurs waiting delays and decreases throughput. Goldschmidt's algorithm uses two multiplication operations which are independent and therefore may be performed simultaneously via pipelining. Unfortunately, current error estimates for Goldschmidt's algorithm are imprecise, requiring high-precision multiplication operations for stability, thereby reducing the advantages of the pipelining. A new error analysis provides improved methods for estimating the error in the Goldschmidt algorithm iterations, resulting in reductions in the hardware, improved pipeline organization, reducing the number and length of clock cycles, reducing latency, and increasing throughput.

The present application claims benefit of U.S. Provisional Patent Application No. 60/421,998 filed Oct. 29, 2002.

### FIELD OF THE INVENTION

The present invention relates to numerical data processing apparatus and methods, and, more particularly, to an apparatus and method for performing floating-point division conforming to IEEE formatting and rounding standards.

### INCORPORATED MATERIAL

The following material is incorporated for all purposes into the present application in appendices as listed below, following the bibliography:

Appendix A. “Apparatus for pipelined division with IEEE rounding”, by Guy Even and Peter-M. Seidel, U.S. Provisional Patent Application 60/421,998 filed Oct. 29, 2002.

Appendix B. “Pipelined multiplicative division with IEEE rounding”, by Guy Even and Peter-M. Seidel.

Appendix C. “A parametric error analysis of Goldschmidt's division algorithm”, by Guy Even, Peter-M. Seidel, and Warren E. Ferguson, in Proceedings of the 16th IEEE Symposium on Computer Arithmetic, Jun. 15-18, 2003.

Appendix D. “Deeply pipelined multiplicative division with IEEE rounding using a full size multiplier with redundant feedback”, by Guy Even and Peter-M. Seidel.

### BACKGROUND OF THE INVENTION

As the capabilities of microprocessors have increased, hardware modules dedicated to IEEE floating-point division have became common in microprocessors. Appendix A.-Table 1 lists the latencies (i.e., number of cycles required to complete an instruction) and restart times (i.e., number of cycles that elapse until a functional module can engage in a new independent computation) of floating-point division modules in various microprocessors. It is easy to see that floating point division is rather slow compared to addition and multiplication. The relevant IEEE standard is IEEE Standard for Binary Floating-Point Arithmetic, ANSI/IEEE 754-1985

When division is performed by numerical iteration using Newton's well-known method, it is necessary to perform two multiplication operations, one of which is dependent on the result of the other, thereby requiring that the multiplication operations be performed sequentially. This requirement limits the speed and efficiency of division operations using Newton's method. In contrast, the well-known algorithm of Goldschmidt, which also requires two multiplication operations, relies on two multiplication operations which are independent of one another, and which can therefore be performed simultaneously to improve the speed and efficiency of the division. In terms of processor architecture, Goldschmidt's division algorithm is more amenable to pipelined and parallel implementations.

Unfortunately, however, there is currently in the prior art no satisfactory measure of the error when employing the Goldschmidt algorithm, and without a good measure of error, the inaccuracies of the intermediate iterative computations accumulate and cause the computed result to drift away from the correct quotient. That is, implementations of Goldschmidt's algorithm are not self-correcting. The lack of a general and simple error analysis of Goldschmidt's division algorithm has deterred many designers from implementing Goldschmidt's algorithm. Thus, most implementations of multiplicative division methods have been based on Newton's method in spite of the longer latency due to dependent multiplications in each iteration.

Those who have utilized Goldschmidt's algorithm have had to keep careful track of accumulated and propagated error terms during intermediate computations. Recent implementations of Goldschmidt's division algorithm still rely on an error analysis that over-estimates the accumulated error. Such over-estimates lead to correct results but require a costly full-precision multiplier circuit that wastes hardware resources and causes unnecessary delay, because the multiplier and the initial lookup table are too large.

The lack of an accurate error estimator therefore discourages the use of Goldschmidt's division algorithm, and prevents an efficient realization of the pipeline advantages of Goldschmidt's algorithm when implemented. This results in increased hardware complexity, power consumption, processing time, and latency for division operations.

There is thus a widely recognized need for, and it would be highly advantageous to have, a compact, accurate, and efficient error estimator for a Goldschmidt division algorithm conforming to IEEE formatting and rounding standards. This goal is met by the present invention.

### SUMMARY OF THE INVENTION

The present invention is of an apparatus and method conforming to IEEE formatting and rounding standards, which efficiently and accurately estimates error when using Goldschmidt's algorithm. This allows efficient use of pipelining to increase the speed of floating-point division operations.

In an embodiment of the present invention, multiplication is performed by a Booth recoded multiplier that can be fed by:

(a) a redundant Booth recoded operand and a non-redundant binary operand;

(b) two redundant carry-save operands; or

(c) two non-redundant binary operands.

In another embodiment of the present invention, IEEE rounding is performed by a novel “dewpoint” rounding technique that implements dewpoint rounding with back multiplication. Performing back multiplication with an estimated dewpoint allows the use of a half-size multiplier instead of a full-size multiplier in estimating Goldschmidt algorithm error.

Accordingly, yet another embodiment of the present invention utilizes a half-size multiplier in performing Goldschmidt's algorithm, yielding IEEE-correct rounding while offering the advantages of:

(a) reduced hardware;

(b) improved pipeline organization;

(c) fewer clock cycles;

(d) shorter clock cycles;

(e) reduced latency;

(f) increased throughput; and

(g) lower power consumption.

Therefore, according to the present invention there is provided a method for IEEE-rounding a computed quotient in a processor, the computed quotient corresponding to an exact quotient which equals a dividend divided by a divisor, the method including: (a) determining an error range of the exact quotient; (b) determining a first candidate number and a second candidate number from the error range; (c) associating the first candidate number with a first rounding interval containing numbers that are IEEE-rounded to the first candidate number; (d) associating the second candidate number with a second rounding interval containing numbers that are IEEE-rounded to the second candidate number; (e) computing the dewpoint number, which separates the first rounding interval from the second rounding interval; (f) back-multiplying the dewpoint number by multiplying the dewpoint number by the divisor; and (g) comparing the back-multiplied dewpoint number against the dividend to determine whether the first candidate number represents the IEEE-rounded computed quotient, or whether the second candidate number represents the IEEE-rounded computed quotient.

Furthermore, according to the present invention there is provided a Booth multiplier for computing the product of a first operand and a second operand, including: (a) a first stage operative to preparing the first operand and the second operand for the addition of partial products, and operative to recoding the second operand in Booth radix-8 digits, and operative to generating partial products; (b) a second stage having an adder tree operative to compressing the partial products; and (c) a third stage having an adder operative to compressing the carry-save representation of the product to a binary representation.

### DESCRIPTION OF THE PREFERRED EMBODIMENTS

The principles and operation of an apparatus and method according to the present invention may be understood with reference to the accompanying description and the material in the appendices, which disclose the detailed mathematical principles, circuit diagrams, examples, and other information to completely explain implementing the invention.

“Dewpoint” Rounding

The present invention discloses a novel rounding procedure for IEEE floating point division (see Appendix D-Section 4), which is herein referred to as “dewpoint” rounding—so-called because of the analogy to the meteorological temperature below which condensation of moisture occurs, and above which condensation of moisture does not occur. The procedure relies on an error range of the quotient that allows for only two candidate numbers for the final IEEE rounded result. Each candidate number is associated with a rounding interval, which is simply the set of numbers that are IEEE-rounded to the candidate number. The dewpoint is defined to be the number separating the two rounding intervals. The rounding decision is obtained by comparing the dewpoint against the exact quotient by applying back-multiplication. This comparison determines which of the candidate numbers is the correct IEEE-rounded result. Appendix D-Section 4 discloses the details of a unified dewpoint rounding procedure for all IEEE rounding modes, thereby eliminating the need for rounding tables.

The novel dewpoint rounding of the present invention represents an improvement over current prior-art approaches for implementing IEEE rounding in division, which first compute a “rounding representative” of the exact quotient (i.e., a number that belongs to the same rounding interval to which the exact quotient belongs), and then round the rounding representative.

An optimized implementation of dewpoint rounding and back multiplication is disclosed in detail in Appendix B-Section 7.6 and in Appendix D-Section 5.3.

To compute the dewpoint, use a rounding injection and a dewpoint displacement constant (as detailed in Appendix D-Section 4.2). The rounding injection is added to the computed quotient, which is then truncated. The dewpoint displacement constant is then added to the truncated computed quotient to obtain the dewpoint.

All the intermediate results mentioned here (the computed quotient, the truncated computed quotient, and the dewpoint) are also represented in redundant representation. This means that each of the additions mentioned above can be computed in constant time (i.e., they do not require a carry-propagate adder with a logarithmic delay). This enables a reduction of the four IEEE rounding modes to a single rounding mode, so that each separate mode need not be dealt with separately.

Furthermore, the test to determine which of the candidate numbers represents the proper rounding of the computed quotient involves evaluating whether the quantity (b*dewpoint−a) is zero, positive, or negative. It is noted that the dewpoint is very close to the exact quotient a/b, so that the absolute value of this quantity is very small, and the sign (or zero) of this quantity can be determined by the least-significant few bits. Thus, the hardware used to determine the sign (or zero) can be fed by a small subset of the least-significant bits.

Moreover, in yet another embodiment of the present invention, the back-multiplication is split into two half-size multiplication operations that can be performed in consecutive clock cycles using the same multiplier (refer to cycles 8 and 9 in Appendix B-Table 3). The first part of the back-multiplication is done with an estimated dewpoint (as shown in Appendix B-Section 7.6). The estimated dewpoint is computed from the computed quotient of the previous iteration. An apparatus according to this embodiment of the present invention utilizes a half-size multiplier for the dewpoint back-multiplication, thereby reducing hardware requirements.

Multiplier Hardware Optimization

Addition trees in multipliers are not amenable to pipelining. Short clock cycles are therefore not achievable at reasonable cost if the addition tree has too many rows. Booth radix-8 recoding reduces the number of rows in an addition tree from n to (n+1)/3.

Booth radix-8 multipliers are usually implemented using a 3-stage pipeline, as follows:

1. precompute the 3× multiple of the first operand of the multiplier and recode the second operand;

2. an addition tree that computes a carry-save representation of the product; and

3. final carry-propagate addition.

Goldschmidt's algorithm performs only two multiplications per iteration. Hence running Goldschmidt's algorithm on a 3-stage pipeline creates unutilized cycles (“bubbles”) in the pipeline. These bubbles increase the latency and reduce the throughput. Certain prior-art processors attempt to utilize these bubbles (and increase throughput) by allowing other multiplication operations to be executed during such bubbles.

The present invention discloses a Booth radix-8 multiplier that allows for both operands to be either in nonredundant representation or carry-save representation. Booth multipliers with one operand in redundant carry-save representation are known in the prior art, but Booth multipliers with both operands in redundant representation conceptually is a novel feature of the present invention, which reduces the 3-stage pipeline to a 2-stage pipeline for all but the last iteration of the algorithm.

The Booth-8 multiplier design that supports operands in redundant representation is not symmetric, in the sense that the first operand and second operand of the multiplier are processed differently during the first pipeline stage. During the first pipeline stage, operands represented as carry-save numbers are processed as follows:

(a) The first operand is compressed and the 3× multiple thereof is computed. This requires two adders.

To reduce hardware requirements, an embodiment of the present invention employs the adder from the third pipeline stage for compressing the first operand. In this embodiment, the compression of the first operand appears in Appendix D-Table 2 as an operation that takes place in the third pipeline stage.

(b) The second operand can be partially compressed from carry-save representation before being fed to the Booth recoder. In Appendix D-“Implementation of the dewpoint computation” a recoding method is detailed.

A method for determining the Booth recoding of the dewpoint correction term is detailed in Appendix B-Section 7. This method is based on a bound on the value of the dewpoint correction term, which determines the most significant digit position i involved in the computation (i=24 in Appendix B-Figure 3).

A first Booth recoded operand of the dewpoint correction term is computed modulo 2⁻ⁱ, which has either the value of the dewpoint correction term or the value of the dewpoint correction term plus 2⁻ⁱ. A second Booth recoded operand is computed in the same manner, minus 2⁻ⁱ. Only the most significant Booth recoded digit of the second Booth recoded operand needs to be computed. The other digits are the same as in the first Booth recoded operand.

In parallel with the above computations, a signal is computed that indicates whether the first Booth recoded operand represents the dewpoint correction term plus 2⁻ⁱ. If the signal is a zero, the first Booth recoded operand represents the dewpoint correction constant, and is chosen as the Booth recoded operand. If the signal is a one, the Booth rcoded operand represents the dewpoint correction constant plus 2⁻ⁱ and the second Booth recoded operand is chosen as the Booth recoded operand. For example, 2⁻ⁱ=2⁻²⁴ in Appendix B-Figure 3.

In an embodiment of the present invention, a Booth recoded multiplier can be fed by either non-redundant binary operands or by redundant carry-save operands. When applied to a Booth radix-8 multiplier, this enables reducing the feedback latency to two cycles. The prior art features only Booth multipliers with one operand in redundant carry-save representation or signed-digit representation.

The organization of a Booth multiplier according to this embodiment of the present invention has the following stages, as detailed in Appendix D-Section 5.1.

Stage 1. The two operands of the multiplier are prepared for the addition of the partial products in the second stage. The second operand is recoded in Booth radix-8 digits and the partial products are generated. If the second operand is given in carry-save representation, a partial compressor prepares the second operand for the input of a conventional Booth recoder. The recoding can accept either a binary string or a carry-save encoded digit string. The first operand is processed as follows: The 3× multiple of the operand is computed using an adder. The first operand can be represented in either binary or redundant carry-save representation. For the case where the first operand is encoded as a carry-save digit string, the computation of the 3× multiple is preceded by a 4:2 adder that computes a carry-save encoding of the 3× multiple. This carry-save encoded digit string is compressed to a binary number by the adder. For the case where the first operand is encoded as a carry-save digit string, the binary representation of the operand is also computed by a binary adder. The binary adder from the third pipeline stage can be used for this purpose if available for carry-save feedback operands. This can save an adder in the first pipeline stage.

Stage 2. In the second stage, the partial products are compressed by an adder tree. In addition to the partial products, an additional row can be dedicated for an additive input.

Stage 3. The third stage contains an adder to compress the carry-save representation of the product to a binary representation. This adder can be shared with the first pipeline stage.

Appendix D-Section 6.1 details how a full size multiplier is used in a floating point divider. Appendix B-Section 6 details how a half-sized multiplier is used.

While the invention has been described with respect to a limited number of embodiments, it will be appreciated that many variations, modifications and other applications of the invention may be made.

### Bibliography

[1] R. C. Agarwal, F. G. Gustavson, and M. S. Schrnookler. Series approximation methods for divide and square root in the power3 processor. In Proceedings of the 13th IEEE Symposium on Computer Arithmetic, volume 14, pages 116-123. IEEE, 1999.

[2] S. F. Anderson, J. G. Earle, R. E. Goldschmidt, and D. M. Powers. The IBM 360/370 model 91: floating-point execution unit. IBM Journal of Research and Development, January 1967.

[3] P. Beame, S. Cook, and H. Hoover. Log depth circuits for division and related problems. SIAM Journal on Computing, 15:994-1003, 1986.

[4] G. W. Bewick. Fast Multiplication: Algorithms and Implementation. PhD thesis, Stanford University, March 1994.

[5] Marius A. Cornea-Hasegan, Roger A. Golliver, and Peter Markstein. Correctness proofs outline for Newton-Raphson based floating-point divide and square root algorithms. In Koren and Kornerup, editors, Proceedings of the 14th IEEE Symposium on Computer Arithmetic (Adelaide, Australia), pages 96-105, Los Alamitos, Calif., April 1999. IEEE Computer Society Press.

[6] D. DasSarma and D. W. Matula. Faithful bipartite ROM reciprocal tables. In S. Knowles and W. H. McAllister, editors, Proc. 12th IEEE Symposium on Computer Arithmetic, pages 17-28, 1995.

[7] M. Daumas and D. W. Matula. Recoders for partial compression and rounding. Technical Report 97-01, Laboratoire de l'Informatique du Parallélisme, Lyon, France, 1997.

[8] M. Daumas and D. W. Matula. A Booth multiplier accepting both a redundant or a non-redundant input with no additional delay. In IEEE International Conference on Application-specific Systems, Architectures and Processors, pages 205-214, 2000.

[9] G. Even, S. M. Mueller, and P. M. Seidel. A Dual Mode IEEE multiplier. In Proceedings of the 2nd IEEE International Conference on Innovative Systems in Silicon, pages 282-289. IEEE, 1997.

[10] G. Even and W. J. Paul. On the design of IEEE compliant floating point units. In Proceedings of the 13th Symposium on Computer Arithmetic, volume 13, pages 54-63. IEEE, 1997.

[11] G. Even and P. -M. Seidel. A comparison of three rounding algorithms for IEEE floating-point multiplication. IEEE Transactions on Computers, Special Issue on Computer Arithmetic, pages 638-650, July 2000.

[12] Guy Even and Peter-M. Seidel. Pipelined multiplicative division with IEEE rounding. In Proceedings of the 21st International Conference on Computer Design, Oct. 13-15 2003.

[13] Guy Even, Peter-M. Seidel, and Warren E. Ferguson. A parametric error analysis of Goldschmidt's division algorithm. In Proceedings of the 16th IEEE Symposium on Computer Arithmetic, Jun. 15-18 2003. Full version submitted to JCSS.

[14] D. Ferrari. A division method using a parallel multiplier. IEEE Transactions on Computers, EC-16:224-226, April 1967.

[15] M. J. Flynn. On division by functional iteration. IEEE Transactions on Computers, C-19(8):702-706, August 1970.

[16] R. E. Goldschmidt. Applications of division by convergence. Master's thesis, MIT, June 1964.

[17] IEEE standard for binary floating-point arithmetic. ANSI/IEEE754-1985, New York, 1985.

[18] Cristina Iordache and David W. Matula. On infinitely precise rounding for division, square root, reciprocal and square root reciprocal. In Koren and Kornerup, editors, Proceedings of the 14th IEEE Symposium on Computer Arithmetic (Adelaide, Australia), pages 233-240, Los Amlamitos, Calif., April 1999. IEEE Computer Society Press.

[19] H. Kabuo, T. Taniguchi, A. Miyoshi, H. Yamashita, M. Urano, H. Edamatsu, and S. Kuninobu. Accurate rounding scheme for the Newton-Raphson method using redundant binary representation. IEEE Transactions on Computers, 43(1):43-51, 1994.

[20] D. E. Knuth. The Art of Computer Programming, volume 2. Addison-Wesley, 3nd edition, 1998.

[21] E. V. Krishnamurthy. On optimal iterative schemes for high-speed division. IEEE Transactions on Computers, C-19(3):227-231, March 1970.

[22] P. Markstein. Ia-64 and Elementary Functions: Speed and Precision. Hewlett-Packard Professional Books. Prentice Hall, 2000.

[23] K. Mehlhorn and F. P. Preparata. Area-time optimal division for t=ω((logn)^{1+ε}). Information and Computation, 72(3):270-282, 1987.

[24] P Montuschi and T. Lang. Boosting very-high radix division with prescaling and selection by rounding. IEEE Transactions on Computers, 50(1):13-27, 2001.

[25] Silvia M. Mueller and Wolfgang J. Paul. Computer Architecture. Complexity and Correctness. Springer, 2000.

[26] J. M. Muller. Elementary Functions, Algorithms and Implementation. Birkhauser, Boston, 1997.

[27] S. F. Oberman and M. J. Flynn. Design issues in division and other floating-point operations. IEEE Transactions on Computers, 46(2):154-161, February 1997.

[28] Stuart F Oberman. Floating-point division and square root algorithms and implementation in the AMD-K7 microprocessor. In Koren and Kornerup, editors, Proceedings of the 14th IEEE Symposium on Computer Arithmetic (Adelaide, Australia), pages 106-115, Los Alamitos, Calif., April 1999. IEEE Computer Society Press.

[29] W. J. Paul and P. -M. Seidel. On the Complexity of Booth Recoding. Proceedings of the 3rd Conference on Real Numbers and Computers(RNC3), pages 199-218, 1998.

[30] J. H. Reif and S. R. Tate. Optimal size integer division circuits. SIAM Journal on Computing, 19(5):912-924, October 1990.

[31] D. M. Russinoff. A mechanically checked proof of IEEE compliance of a register-transfer-level specification of the amd-K7 floating-point multiplication, division, and square root instructions. LMS Journal of Computation and Mathematics, 1:148-200, December 1998.

[32] M. R. Santoro, G. Bewick, and M. A. Horowitz. Rounding algorithms for IEEE multipliers. In Proceedings 9th Symposium on Computer Arithmetic, pages 176-183, 1989.

[33] E. M. Schwarz, L. Sigal, and T. McPherson. CMOS floating point unit for the S/390 parallel enterpise server G4. IBM Journal of Research and Development, 41(4/5):475-488, July/September 1997.

[34] E. M. Schwarz. Rounding for quadratically converging algorithms for division and square root. In Proceedings of the 29th Asilomar Conference on Signals, Systems and Computers, volume 29, pages 600-603. IEEE, 1996.

[35] P. -M. Seidel. High-speed redundant reciprocal approximation. INTEGRATION, the VLSI Journal, 28:1-12, 1999.

[36] P.- M. Seidel. On the Design of IEEE Compliant Floating-Point Units and their Quantitative Analysis. PhD thesis, University of Saarland, Computer Science Department, Germany, 1999.

[37] N. Shankar and V. Ramachandran. Efficient parallel circuits and algorithms for division. Information Processing Letters, 29(6):307-313, 1988.

[38] P. Soderquist and M. Leeser. Area and performance tradeoffs in floating-point divide and square-root implementations. ACM Computing Surveys, 28(3):518-564, September 1996.

[39] O. Spaniol. Computer Arithmetic—Logic and Design. Wiley, 1981.

[40] N. Takagi. Arithmetic unit based on a high speed multiplier with a redundant binary addition tree. In Advanced Signal Processing Algorithms, Architectures and Impleme ntation II, vol. 1566 of Proceedings of SPIE, pages 244-251, 1991.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for IEEE-rounding a computed quotient in a processor, the computed quotient corresponding to an exact quotient which equals a dividend divided by a divisor, the method comprising:
(a) determining an error range of the exact quotient;
(b) determining a first candidate number and a second candidate number from the error range;
(c) associating the first candidate number with a first rounding interval containing numbers that are IEEE-rounded to the first candidate number;
(d) associating the second candidate number with a second rounding interval containing numbers that are IEEE-rounded to the second candidate number;
(e) computing the dewpoint number, which separates the first rounding interval from the second rounding interval;
(t) back-multiplying the dewpoint number by multiplying the dewpoint number by the divisor; and
(g) comparing the back-multiplied dewpoint number against the dividend to determine whether the first candidate number represents the IEEE-rounded computed quotient, or whether the second candidate number represents the IEEE-rounded computed quotient.

2. The method as recited in claim 1, wherein computing the dewpoint number comprises:
(h) adding a rounding injection to the computed quotient;
(i) truncating the computed quotient;
(j) determining a dewpoint displacement constant; and
(k) adding the dewpoint displacement constant to the truncated computed quotient.

3. The method as recited in claim 1, wherein comparing the back-multiplied dewpoint number against the exact quotient comprises:
(h) subtracting the dividend from the back-multiplied dewpoint number to compute a difference; and
(i) utilizing only a subset of the least-significant bits of the difference to determine whether the difference is zero, and, if the difference is not zero, determining whether the difference is positive or negative.

4. An apparatus for performing the method as recited in claim 3, comprising a half-size multiplier to perform back-multiplying the dewpoint number.

5. A method for determining the Booth recoding of a correction term for a dewpoint number as recited in claim 1, given a digit position i the method comprising:
(h) computing a first Booth recoded operand of the correction term modulo 2⁻ⁱ;
(i) computing a second Booth recoded operand equal to the first Booth recoded operand minus 2⁻ⁱ;
(j) computing a signal indicating whether the first Booth recoded operand represents the correction term plus 2⁻ⁱ; and
(k) choosing, if the signal is zero, the first Booth recoded operand to represent the correction constant, and choosing the second Booth recoded operand to represent the correction constant otherwise.

6. A Booth multiplier for computing the product of a first operand and a second operand, comprising:
(a) a first stage operative to preparing the first operand and the second operand for the addition of partial products, and operative to recoding the second operand in Booth radix-8 digits, and operative to generating partial products;
(b) a second stage having an adder tree operative to compressing the partial products; and
(c) a third stage having an adder operative to compressing the carry-save representation of the product to a binary representation.
